(19) United States
(12) Patent Application Publication
(10) Pub. No.: US 2006/0218276 A1
(43) Pub. Date: Sep. 28, 2006

(54) Workstation for analyzing and optimizing a cellular mobile telecommunications network

(75) Inventors: Jean-Roch Houllier, Saint-Michel sur Orge (FR); Alain Brethereau, Viroflay (FR); Beatrix Demathan, Paris (FR)

Correspondence Address: SUGHRUE MION, PLLC, 2100 PENNSYLVANIA AVENUE, N.W., SUITE 800, WASHINGTON, DC, 20037, US

(73) Assignee: EVOLIUM S.A.S.

(21) Appl. No.: 11/376,086

(22) Filed: Mar. 16, 2006

(30) Foreign Application Priority Data
Mar. 17, 2005 (FR) 0550688

(51) Int. Cl. G06F 15/173

(52) U.S. Cl. 709/225

(57) ABSTRACT

The workstation (10) for analyzing and optimizing a cellular mobile telecommunications network includes a set of cells each characterized by one or more neighbor relationships with one or more neighbor cells. It includes:
a unit (14) for displaying a map showing two or more cells;
an interface (24) enabling an operator to define the neighbor relationship between two cells; and means for analyzing the operation of the network as a function of the neighbor relationships so defined.

Said interface includes means (24) for direct selection on the map of two or more cells and means for defining a neighbor relationship between the selected cells.

The present invention relates to a workstation for analyzing and optimizing a cellular mobile telecommunications network that comprises a set of cells each of which is associated with a base station that is adapted to communicate with one or more mobile stations present in the cell, each cell being characterized by one or more neighbor relationships with one or more neighbor cells such that the base stations of two cells linked by a neighbor relationship are adapted to switch a call from the same mobile station between the two base stations of the two linked cells to enable the mobile station to pass from one cell to the other without the call being interrupted, the workstation including:

a unit for displaying a map showing two or more cells;

an interface enabling an operator to define the neighbor relationship between two cells; and

means for analyzing the operation of the network as a function of the neighbor relationships so defined.

Using workstations to analyze and optimize cellular mobile telecommunications networks by means of software adapted to model the network and analyze its behavior on the basis of information resulting from measurements effected in the field, intrinsic characteristics of the elements constituting the network and/or the morphology of the terrain in which the network is installed is known in the art.

In a cellular network, each mobile station communicates with one or more base stations defining a cell in which each mobile station present communicates with the base station. This is known in the art.

To enable mobile stations to move around without calls being interrupted, it is known in the art for a mobile station passing from one cell into a neighbor cell to have its call switched between the base stations of the source and destination cells as a function of geographical criteria, the topology of the network or network parameter values. This procedure for switching calls between two base stations is referred to as “handover” in the standards, in particular in the GSM and UMTS standards.

When a network is being configured, these switching options are configured and two neighboring cells for which it is possible to switch a mobile station's calls to their base stations are characterized as neighbor cells. A neighbor relationship is thus defined between them.

For any given two cells, a neighbor relationship may be materially impossible if there is a coverage gap affecting the two cells; if a neighbor relationship is possible, provision may be made for it at configuration time, or it may be prohibited in order to prevent switching calls from one cell to the other.

The workstations adapted to analyze and optimize a cellular mobile telecommunications network take these neighbor relationships into account in order to supply results that the user can use.

In particular, they include a software module for determining from the topology of the network and the characteristics of the base stations candidate neighbor cells for each cell, i.e. cells meeting required predetermined criteria such as contiguity, overlapping coverage areas, parameter values or network topology.

By default, all neighbor relationships with candidate cells are set up for the purpose of analyzing the operation of the network.

When the configuration of the network is being optimized, a user working at a workstation intentionally sets up, modifies or eliminates neighbor relationships between cells.

To do this, the user must modify certain parameters in a data structure representing the configuration of the network. To this end, the workstation makes available to the user a succession of dialogue boxes with fields to be filled in to program setting up, modifying or eliminating a neighbor relationship between two cells.

The above kind of workstation is relatively complicated to use and is not user-friendly, in particular if the user must frequently modify certain neighbor relationships during network optimization.

An object of the invention is to propose a workstation providing a simple way to set up neighbor relationships between cells.

To this end, the invention consists in a workstation of the above-specified type characterized in that said interface includes means for direct selection on the map of two or more cells and means for defining a neighbor relationship between the selected cells.

Particular embodiments of the workstation have one or more of the following features:

it includes processing means adapted to determine automatically neighbor relationships between cells for optimizing the network on the basis of known characteristics of the network;

it includes means for storing a data structure including parameters defining neighbor relationships between cells and the means for defining a neighbor relationship between selected cells include means for modifying parameters defining the neighbor relationship in said data structure;

said means for defining a neighbor relationship between selected cells include a selection window displayed on the display unit and means for selecting one or more parameters in said window;

the means for direct selection on the map of two or more cells include a mouse and a cursor movable over the screen under the control of the mouse; and

said interface is adapted to define candidate neighbor relationships and the station includes means for validating each candidate neighbor relationship so defined during a subsequent optimization phase.

The invention will be better understood on reading the following description, which is given by way of example only and with reference to the appended drawings, in which:

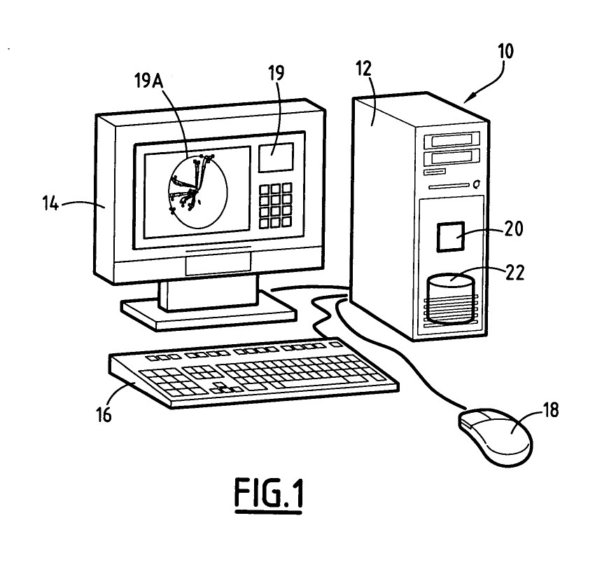

FIG. 1 is a diagrammatic perspective view of a workstation of the invention;

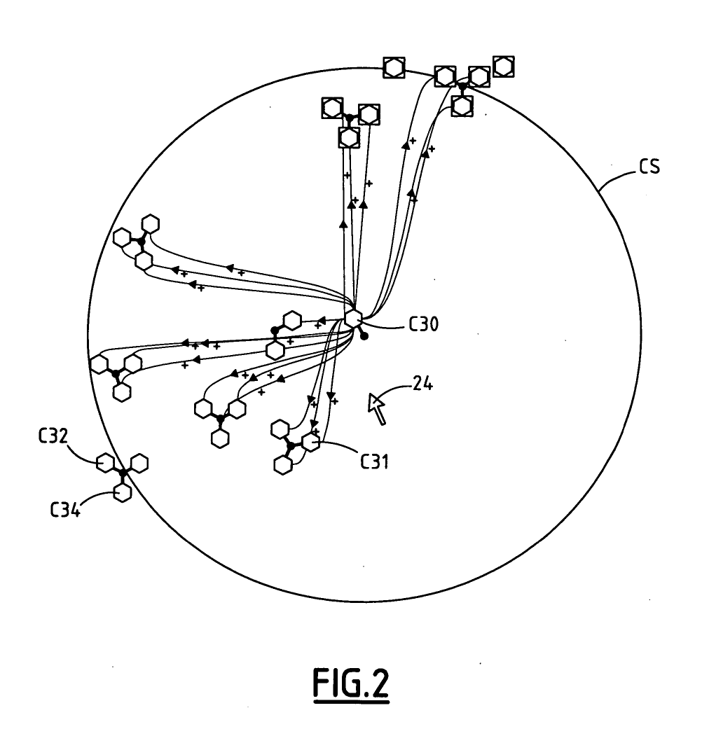

FIG. 2 is a diagram of an enlarged portion of a map displayed on the FIG. 1 workstation;

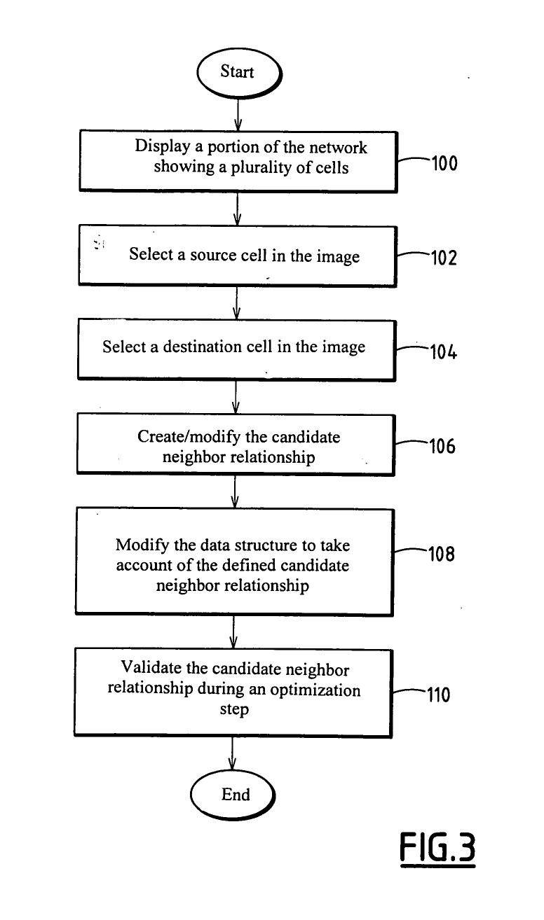

FIG. 3 is a flowchart of an algorithm for defining neighbor relationships between cells used by the FIG. 1 workstation; and

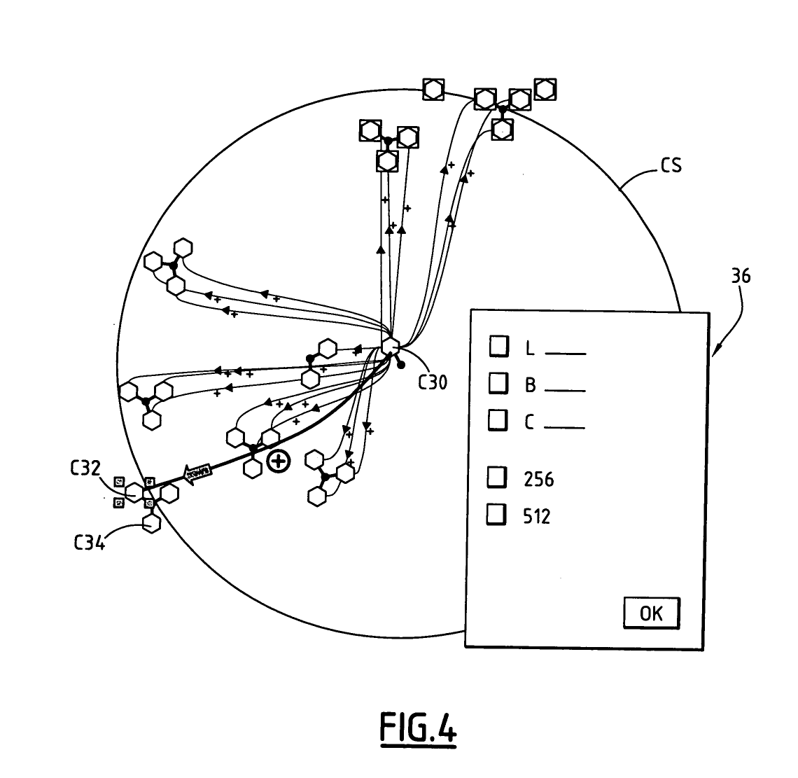

FIG. 4 is a view identical to that of FIG. 2 after a neighbor relationship has been set up between two particular cells.

The workstation 10 shown in FIG. 1 is for analyzing the operation of and optimizing a cellular mobile telecommunications network.

The workstation uses appropriate software to display a map representing the mobile telephone network concerned. This is known in the art.

Accordingly, the station includes a central data processing unit 12, a display screen 14 and means forming a man/machine interface such as a keyboard 16 and/or a mouse 18 for selecting functions from a graphical user interface 19 displayed on the screen 14. The interfaces are adapted in particular to provide for the selection of graphical elements on the display.

The data processing unit 12 includes a processor 20 for executing a computer program for processing data and controlling the display on the screen 14, in particular on the basis of information received from the keyboard 16 and/or the mouse 18.

The unit 12 further includes data storage means 22 such as a hard disc on which are stored a description of a map of the network and a program executed by the workstation.

The stored description of a map of the network includes in particular the position of the base stations installed in the territory that are adapted to communicate with the mobile stations, together with configuration parameters and characteristics of each base station.

A cell is defined for each base station. This is known in the art. It corresponds to the region within which each mobile station is able to communicate with the corresponding base station. The contour of each cell depends on the configuration of the network and in particular on the configuration of the base stations.

For simplicity, each cell is represented graphically on the screen 14 by a hexagonal icon, as shown in FIG. 2. The cells or sectors that are local to the same base station are connected to the same black dot by a straight line segment. The workstation is advantageously such that the cell representations on the map are spaced by a distance proportional to the actual distance between the cells in question.

The data storage means 22 have a data structure in which characteristics of each cell and of the network are stored. The characteristics of the network include in particular the neighbor relationships defined between cells.

When it is defined, a neighbor relationship between two cells provides the possibility for a mobile station to switch its call between the base stations of the two cells in order to be able to move from one cell to the other without the call being interrupted.

This neighbor relationship depends on a number of parameters, and in particular on the type of switching used to pass from one cell to the other and on the interference threshold. Each neighbor relationship may be one-way or two-way, i.e. it may authorize continuation of the call from one cell to the other in only one direction of movement of the mobile station or in both directions.

For each base station, and therefore for each associated cell, the data storage means 22 further contain one or more variables characteristic of the operation of the network, each variable advantageously being known at a plurality of successive times over the same time period, for example every hour over one day.

These characteristic variables include quality of service counters or indicators, logical state parameters and network design parameters, for example.

The quality of service indicators include the percentage of failed calls, for example, i.e. the number of calls sent from a base station or theoretically received by a base station that it has not been possible to connect through.

The characteristic variables further include the number per unit time of calls from or to a mobile station set up in each cell via the base station.

These characteristic variables are obtained from measurements carried out by the base stations and/or the mobile stations at regular intervals, the characteristic variables being transmitted over the network to the data storage means 22.

The man/machine interface of the workstation 10 includes means for direct selection on the map of a cell shown on the screen.

To this end, the station includes means for moving a cursor 24 over the screen using the mouse 18 and means for validating the selection of a cell over which the cursor is located, for example a button on the mouse.

The workstation 10 further includes means for analyzing the network adapted to produce histograms or any other structured representation of variables characteristic of the operation of the network for each of the cells of the network, these analysis means taking into account neighbor relationships validated by the user of the station during optimization phases.

The display means of the station are such that the neighbor relationships are represented on the screen 14, for example with the aid of curved arrows, for example directed splines, as shown in FIG. 2, each curved arrow being oriented and directed from a source cell C30 to a destination cell C31 for which handover between the mobile station and the base stations of the two cells may be set up.

The color of the curved arrow advantageously represents a characteristic of the defined neighbor relationship.

The workstation 10 includes means for automatically defining, for a given cell, candidate cells with which a neighbor relationship may theoretically be set up, given the morphology of the terrain and the characteristics of the installed base stations. This is known in the art.

Given the limited transmission distances between a mobile station and a base station, for a given cell C30, cells that are candidates for a neighbor relationship are contained within a selection circle Cs in FIG. 2. Cells outside the area delimited by the selection circle Cs are automatically considered not to be neighbor relationship candidates.

This is the case of the cells C32 and C34 in relation to the cell C30, for example.

In addition to the means for automatically defining candidate neighbor relationships, the workstation 10 includes means enabling the user to modify neighbor relationships between cells manually.

These means use the FIG. 3 algorithm.

Initially, in a step 100, a portion of the network is displayed in the manner shown in FIG. 2.

In a step 102, the user is prompted to select a cell whose neighbor relationship must be modified. To this end, the workstation tracks the movement over the screen of the cursor 24, which is controlled by the movement of the mouse by the user. When the cursor 24 is over a cell and the user validates that cell, for example by clicking a button on the mouse, a source cell is selected, for example the cell C30.

In the next step 104, a destination cell, for example the cell C32, is selected in an analogous manner by the user moving the cursor over to the cell C32 and validated by clicking the mouse button.

In a step 106, the user is prompted to modify the existing neighbor relationship between the selected source and destination cells. Thus a candidate neighbor relationship may be set up and the parameters of that neighbor relationship defined; alternatively, if a neighbor relationship already exists, its parameters may be modified or the relationship deleted.

For example, the neighbor relationship is modified by selecting certain parameters in a window 36 appearing on the screen after selecting the destination cell, in the manner shown in FIG. 4.

After the user validates the modification of the neighbor relationship, in a step 108 the workstation modifies the data structure to store in the data the new parameters characteristic of the candidate neighbor relationship.

Subsequently, during a network optimization phase, the candidate neighbor relationship stored in the step 108 and defined by the user in the preceding steps may or may not be validated by the user in a step 110 in order to be taken into account in the analysis of the network effected by the workstation.

Accordingly, with a workstation of the above kind, during optimization phases, users can easily modify the neighbor relationships set up between cells using the means for graphically selecting two cells in order to modify their neighbor relationship to create a candidate neighbor relationship which is validated or not during optimization phases as such, the workstation taking the modified neighbor relationships into account to supply information characteristic of the operation of the network.

Eliminating direct modification of the parameters of the data structure simplifies manual creation of candidate neighbor relationships, thereby facilitating operation of the workstation and the conditions of optimization of the network for the user.

1. A workstation (10) for analyzing and optimizing a cellular mobile telecommunications network that includes a set of cells (C30, C31, C32, C34) each of which is associated with a base station that is adapted to communicate with one or more mobile stations present in the cell, each cell being characterized by one or more neighbor relationships with one or more neighbor cells such that the base stations of two cells linked by a neighbor relationship are adapted to allow the switching of a call from the same mobile station between the two base stations of the two linked cells to enable the mobile station to pass from one cell to the other without the call being interrupted, the workstation including:
a unit (14) for displaying a map showing two or more cells;
an interface (24) enabling an operator to define the neighbor relationship between two cells; and
means for analyzing the operation of the network as a function of the neighbor relationships so defined; the workstation being characterized in that said interface includes means (24) for direct selection on the map of two or more cells and means for defining a neighbor relationship between the selected cells

2. A workstation (10) according to claim 1, characterized in that it includes processing means adapted to determine automatically neighbor relationships between cells for optimizing the network on the basis of known characteristics of the network.

3. A workstation (10) according to claim 1, characterized in that it includes means (22) for storing a data structure including parameters defining neighbor relationships between cells and the means for defining a neighbor relationship between selected cells include means for modifying parameters in said data structure defining the neighbor relationship.

4. A workstation (10) according to claim 1, characterized in that said means for defining a neighbor relationship between selected cells include a selection window (36) displayed on the display unit (24) and means for selecting one or more parameters in said window (36).

5. A workstation (10) according to claim 1, characterized in that the means for direct selection on the map of two or more cells include a mouse (18) and a cursor (24) movable over the screen under the control of the mouse (18).

6. A workstation (10) according to claim 1, characterized in that said interface is adapted to define candidate neighbor relationships and the station includes means for validating each candidate neighbor relationship so defined during a subsequent optimization phase.
